(19) United States
(12) Patent Application Publication
(10) Pub. No.: US 2021/0116053 A1
(43) Pub. Date: Apr. 22, 2021

(54) CABLE MANAGEMENT SYSTEM FOR BASE STATION ANTENNAS

(71) Applicant: CommScope Technologies LLC, Hickory, NC (US)

(72) Inventor: Björn Lindmark, Sollentuna (SE)

(21) Appl. No.: 17/070,000

(22) Filed: Oct. 14, 2020

Related U.S. Application Data
(60) Provisional application No. 62/924,299, filed on Oct. 22, 2019.

(51) Int. Cl. F16L 3/223; F16L 3/13; H02G 3/04; H04W 88/08

(52) U.S. Cl. CPC F16L 3/2235; H04W 88/08; H02G 3/0456; F16L 3/13

(57) ABSTRACT

A cable management system is provided for cellular communications system having a remote radio unit and an antenna where each of the antenna and the remote radio unit include a number of RF ports. A jumper cable assembly connects the RF ports on the antenna to the RF ports on the remote radio unit. The jumper cable assembly includes jumper cables configured to connect the RF ports of the antenna to the RF ports of the remote radio unit. A bracket includes channels where one of the channels receives one of the jumper cables. The position of the channels in the bracket corresponds to the position of the RF ports on the antenna and/or the remote radio unit.

### CROSS-REFERENCE TO RELATED APPLICATION

The present application claims priority under 35 U.S.C. § 119 to U.S. Provisional Application Ser. No. 62/924,299, filed Oct. 22, 2019, the entire content of which is incorporated herein by reference.

### BACKGROUND

Cellular communications systems are used to provide wireless communications to fixed and mobile subscribers (herein “users”). In a typical cellular communications system, a geographic area is divided into a series of regions that are referred to as “cells,” and each cell is served by a base station. Each base station may include baseband equipment, remote radio units and base station antennas that are configured to provide two-way radio frequency (“RF”) communications with users within the cell. The base station antennas and remote radio units are often mounted on a tower or other raised structure.

Base station antennas are directional devices that can concentrate the RF energy that is transmitted or received in certain directions. The “gain” of a base station antenna in a given direction is a measure of the ability of the antenna to concentrate the RF energy in that direction. The radiation pattern that is generated by a base station antenna, which is also referred to as the “antenna beam,” is compilation of the gain of the antenna across all different directions. The radiation pattern of a base station antenna is typically designed to service a pre-defined coverage area such as the cell or a portion thereof that is typically referred to as a “sector.” A base station antenna is typically designed to have minimum gain levels throughout its pre-defined coverage area, and to have much lower gain levels outside of the coverage area to reduce interference with adjacent cells or sectors. Typically, a base station antenna includes one or more phase-controlled arrays of radiating elements, with the radiating elements arranged in one or more vertical columns when the antenna is mounted for use, where “vertical” refers to a direction that is generally perpendicular relative to the plane defined by the horizon.

In order to increase capacity, some cellular base stations now employ beam-forming radios and multi-column beam-forming antennas. In some beam-forming antennas, each column of radiating elements is coupled from a RF port on the antenna to a respective RF port of a remote radio unit. The remote radio unit may adjust the amplitude and phase of the sub-components of an RF signal that are passed to each RF port so that the columns of radiating elements work together to form a more focused, higher gain antenna beam that has a narrowed beamwidth in the azimuth and/or elevation planes.

As the number of columns of radiating elements increases the number of RF ports that must be connected between the remote radio unit and the antenna increases. For example, a four column beam forming array is typically fed by two RF ports per column as well as a calibration port for a total of nine ports. Each RF port on the antenna must be connected to the appropriate RF port on the remote radio unit in order for the remote radio unit to adjust the amplitude and phase of the sub-components of the RF signals that are passed to each RF port so that the columns of radiating elements can work together to form a more focused, higher gain antenna beam. If the RF ports on the remote radio unit are misconnected to the RF ports on the antenna, the system performance will be degraded. Moreover, it may be difficult to detect the cause of the system performance degradation because the physical connection of the RF ports is typically on a raised structure such as a tower.

The connections of the RF ports on the remote radio unit to the RF ports on the antenna are typically made by an installer operating at the top of the tower. The large number of connections that need to be made, the difficult installation conditions, and the increasing complexity of the equipment on the tower can result in the misconnection of the RF ports on the remote radio unit to the RF ports of the antenna.

A jumper cable management system that reduces such misconnections is desired.

### SUMMARY OF THE INVENTION

In some embodiments, a cable management system for connecting an antenna and a radio unit comprises a plurality of jumper cables. A bracket comprises a plurality of channels where one of the plurality of channels receives one of the plurality of jumper cables. The position of the plurality of channels in the bracket corresponds to the position of a plurality of ports on communications equipment to which the plurality of jumper cables are to be connected.

The bracket may comprise a body of resilient, flexible material. The plurality of channels may be substantially C-shaped. The diameter of the one of the plurality of channels may be equal to or slightly less than an outer diameter of the one of the plurality of jumper cables. A fixing mechanism may fix the position of the one of the plurality of jumper cables relative to the one of the plurality of channels. The fixing mechanism may comprise at least one of friction between the one of the plurality of jumper cables and the one of the plurality of channels, compression of at least one of the plurality of jumper cables and the bracket, an adhesive, a sonic weld, an insert molded connection, a rubber grommet, a roughened surface, a plurality of dimples, and a raised ridge on the one of the plurality of channels. The one of the plurality of channels may comprise a lateral opening where the one of the plurality of jumper cables may be inserted into the one of the plurality of channels through the lateral opening. A door may be provided for closing the lateral opening of the one of the plurality of channels. The bracket may comprise a first body portion pivotably connected to a second body portion where the first body portion is movable relative to the second body portion between an open position and a closed position. The first body portion may comprise a plurality of first channel portions and the second body portion may comprise a plurality of second channel portions, wherein when the first body portion and the second body portion are in the closed position the plurality of first channel portions and the plurality of second channel portions combine to form the plurality of channels. The plurality of channels may be formed by a plurality of members and the plurality of members may be connected to one another by a connecting member. The connecting member may be flexible. Each of the plurality of members may include an opening for receiving one of the plurality of jumper cables. The connecting member may comprise at least one of a plastic strip, a rubber strip, a metallic cable, a non-metallic cable, a cord, a textile, a fabric, and a canvas. The bracket and the plurality of channels may be formed from at at least one of a textile material, a fabric material, and a canvas material where a plurality of joints may be formed by at least one of sewing, rivets, and adhesive to create the plurality of channels. The connecting member may comprise a first strip of flexible material, and a second strip of flexible material may be woven to the first strip of material to create the plurality of channels. The connecting member may comprise a first strip of flexible material, and a second strip of flexible material may be interlaced through a plurality of slits in the first strip of flexible material to create the plurality of channels.

In some embodiments, a cable management system for cellular communications system having a remote radio unit and an antenna where each of the antenna and the remote radio unit include a plurality of ports is provided. The cable management system comprises a jumper cable assembly connecting the plurality of ports on the antenna to the plurality of ports on the remote radio unit where the jumper cable assembly comprises a plurality of jumper cables configured to connect the plurality of ports on the antenna to the plurality of ports on the remote radio unit. A bracket includes a plurality of channels where one of the plurality of channels receives one of the plurality of jumper cables. The position of the plurality of channels in the bracket corresponds to the position of the plurality of ports on one of the antenna and the remote radio unit.

In some embodiments, a method of connecting a remote radio unit to an antenna in a cellular communications system where each of the antenna and the remote radio unit include a plurality of ports is provided. The method comprises providing a jumper cable assembly comprising a plurality of jumper cables configured to connect the plurality on ports of the antenna to the plurality of ports on the remote radio unit, and a bracket including a plurality of channels where one of the plurality of channels receives one of the plurality of jumper cables; arranging the plurality of jumper cables in the plurality of channels wherein a position of the plurality of channels corresponds to the position of the ports on one of the antenna and the remote radio unit; and connecting the jumper cables to one of the antenna and remote radio unit based on the position of the plurality of channels in the bracket.

### BRIEF DESCRIPTION OF THE DRAWINGS

FIG. 1 is a schematic diagram illustrating a cellular base station that has three base station antennas that are used to provide coverage to three sectors in the azimuth plane.

FIG. 2 is a perspective view of an embodiment of a beam forming antenna with the radome removed coupled to a remote radio unit according to embodiments of the present invention.

FIG. 3 is a schematic perspective view of another embodiment of a beam-forming antenna with the radome in place.

FIG. 4 is a perspective view of another embodiment of an antenna and remote radio units.

FIG. 5 is a detailed perspective view of a portion of the antenna and one of the remote radio units of FIG. 4.

FIG. 6 is a perspective view of an embodiment of a jumper cable management system bracket.

FIG. 7 is a top view of the jumper cable management system bracket of FIG. 6.

FIG. 8 is a top view of another embodiment of a jumper cable management system bracket.

FIG. 9 is a perspective view of another embodiment of a jumper cable management system bracket.

FIG. 10 is a perspective view of an embodiment of a jumper cable management system bracket connected to communication jumper cables.

FIG. 11 is a perspective view of yet another embodiment of a jumper cable management system bracket.

FIG. 12 is a perspective view of still another embodiment of a jumper cable management system bracket.

FIG. 13 is a perspective view of another embodiment of a jumper cable management system bracket.

FIG. 14 is a perspective view of still another embodiment of a jumper cable management system bracket.

FIG. 15 is a perspective view of yet another embodiment of a jumper cable management system bracket.

FIG. 16 is a perspective view of another embodiment of a jumper cable management system bracket.

FIG. 17 is a perspective view of still another embodiment of a jumper cable management system bracket.

FIG. 18 is a perspective view of yet another embodiment of a jumper cable management system bracket.

FIG. 19 is a perspective view of another embodiment of a jumper cable management system bracket.

FIGS. 20A and 20B are perspective schematic views illustrating the operation of an embodiment of the jumper cable management system of the invention.

FIG. 21 is a perspective schematic view showing a jumper cable assembly according to an embodiment of the jumper cable management system of the invention.

FIGS. 22A and 22B are perspective schematic views illustrating another embodiment of a jumper cable management system bracket.

### DETAILED DESCRIPTION

Pursuant to embodiments of the present invention, a cable management system is provided that facilitates the installation and maintenance of base station antennas and remote radio units.

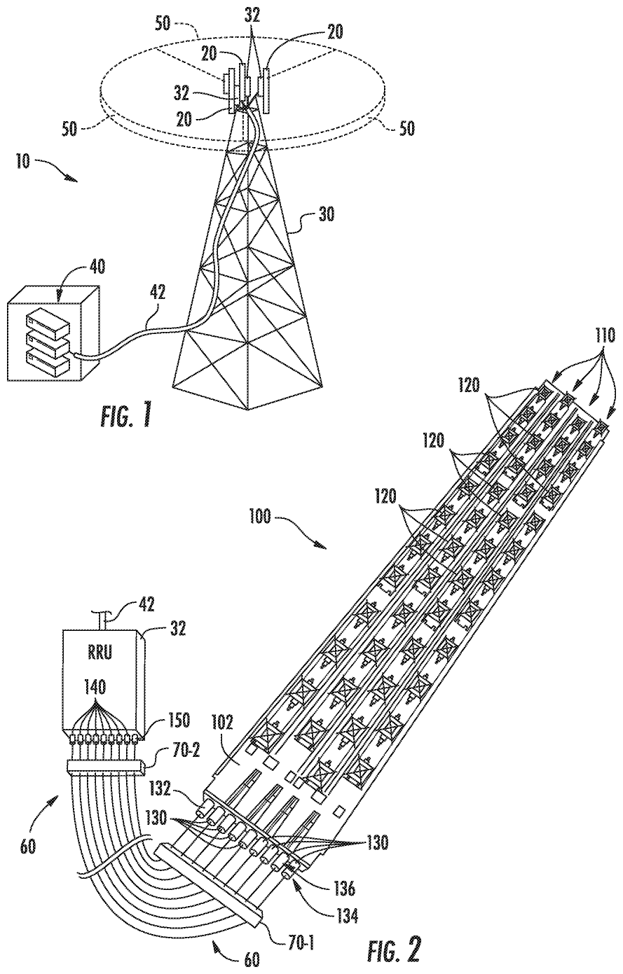

FIG. 1 is a schematic diagram of an example embodiment of a cellular base station 10 in which the cable management system of the invention may be used. The base station 10 includes several base station antennas 20 that are mounted on a raised structure 30 such as an antenna tower. Baseband equipment 40 may be mounted at the base of the tower 30 and cabling connections 42 may connect the baseband equipment 40 to remote radio units (RRUs) 32. The RRUs 32 may be mounted on the structure 30 and are communicatively coupled to the base station antennas 20 by jumper cables 60 (FIG. 2).

Aspects of the present invention will now be in discussed in greater detail with reference to FIG. 2, which illustrates an example embodiment of base station antenna 20. FIG. 2 is a schematic perspective view of a beam-forming antenna 20 that may be connected to a RRU 32 using jumper cables 60. The jumper cables 60 are connected to one or more brackets 70-1, 70-2 of the jumper cable management system of the present invention. The brackets 70-1, 70-2 may comprise any of the brackets as described herein.

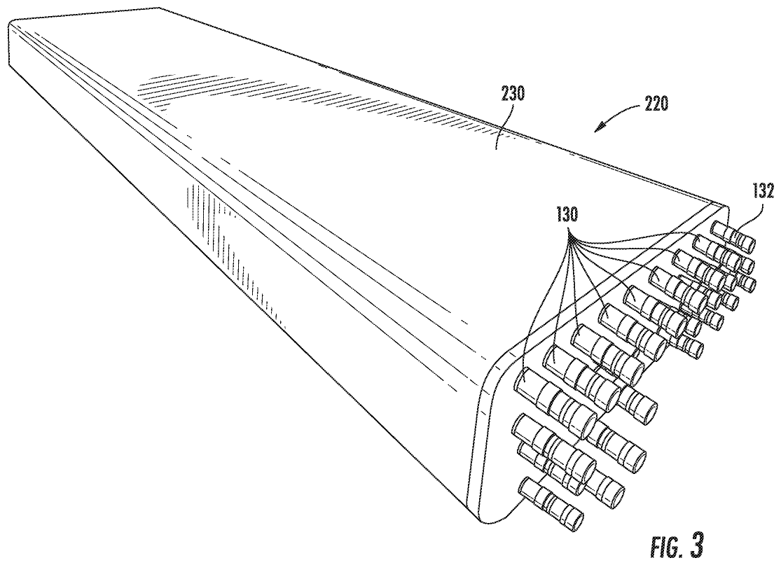

The beam-forming antenna 20 has four columns 110 of dual-polarized radiating elements 120 that are mounted on a planar backplane 102. Each column 110 of radiating elements 120 may have the same azimuth boresight pointing angle. The antenna 20 includes a total of eight RF ports 130, namely two RF ports 130 for each column (a RF port for each polarization), along with a ninth port 132 for calibration. A radome (not shown) is typically mounted over the radiating elements 120 to provide environmental protection. In the embodiment of FIG. 2, the ports 130, 132 are arranged in two rows 134, 136 where the ports on each row are staggered relative to one another. FIG. 3 shows a beam-forming antenna 220 with the radome 230 attached that is similar to the antenna 20 of FIG. 2 except that the RF ports 130 and the calibration port 132 are arranged in a straight-line in a single row.

RF signals may be coupled between the RF ports 130 and the columns 110 of radiating elements 120. Since dual-polarized radiating elements 120 are provided, two RF ports 130 are associated with each column 110, with a first RF port feeding the first polarization radiators (e.g., −45° dipoles) and a second RF port feeding the second polarization radiators (e.g., +45° dipoles). Eight communication jumper cables 60, which may be implemented, for example, as connectorized coaxial jumper cables, may be provided that connect each of the RF ports 130 of the antenna to the corresponding eight RF ports 140 on remote radio unit 32. A ninth jumper cable 60 connects the port 132 from the calibration circuit to the corresponding calibration port 150 on the remote radio unit 32.

In some embodiments, the above-described RF ports, as well as any control ports, are mounted in the bottom end cap 133 of a base station antenna as shown in FIGS. 2 and 3. Mounting the RF ports in this location can help locate the RF ports close to the RRUs 32 that are mounted separate from the antenna 20, which may improve the aesthetic appearance of the installed equipment and reduce RF jumper cable losses. Additionally, mounting the RF ports to extend downwardly from the bottom end cap 133 helps protect the base station antenna from water ingress through the RF ports and may shield the RF ports from rain.

As the number of ports required in some base station antennas is increased, while the overall size of the antennas are kept relatively constant, the spacing between the ports on the bottom end cap may be reduced significantly. This can be seen, for example, in FIG. 3, which is a perspective view of a base station antenna having a large number of ports on the bottom end cap 133. When the RF ports are close together as is the case in the antenna illustrated in FIG. 3, the difficulty for technicians to properly install the jumper cables onto the proper RF ports increases. If a jumper cable is not properly installed onto its corresponding RF port, various problems including passive intermodulation distortion or even loss of the RF connection may occur, requiring expensive and time-consuming tower climbs to correct the situation. In addition, as the density of RF ports is increased, so is the possibility that a technician will connect one or more of the jumper cables 60 to the wrong RF ports, again requiring tower climbs to correct. This problem may be exacerbated by the fact that the denser the array of RF ports the less room there is on the bottom end cap for labels that assist the technician in the installation process.

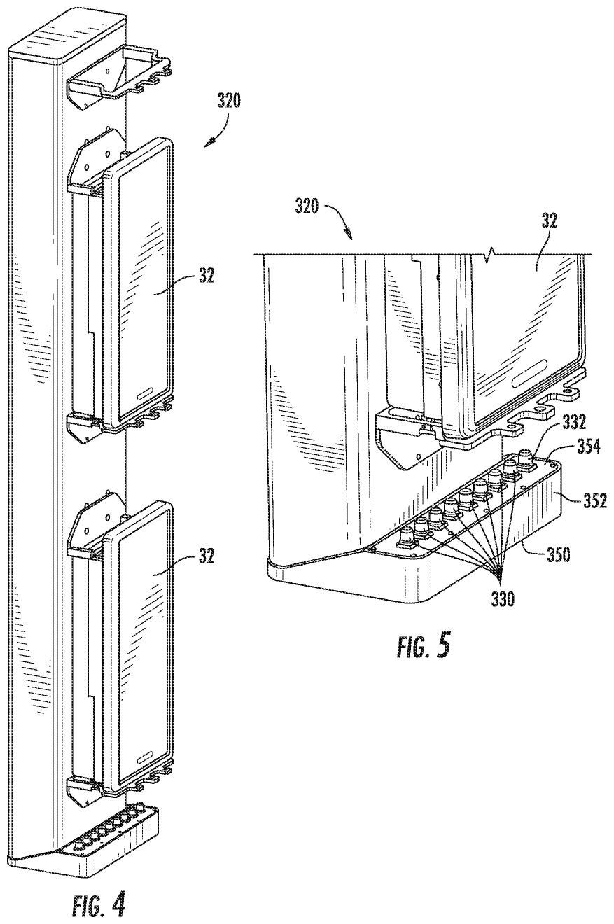

FIG. 4 is a perspective view of an alternate embodiment of a base station antenna 320. FIG. 5 is an enlarged partial perspective view of the base station antenna 320 of FIG. 4. The base station antenna 320 can be similar to the base station antenna 20 that is described above, except that base station antenna 320 has a pair of remote radio units (RRUs) 32 mounted on the rear surface thereof. In addition, the RF ports 330 and the calibration port 332 that are used to connect the linear arrays of antenna 320 to the RRUs 32 may be mounted in a bottom end cap 350. As shown, the RF ports 330 and the calibration port 332 may extend upwardly from an upper surface 354 of a rearwardly extending lip 352 included on the bottom end cap 350. The linear arrays may be arranged as previously described with respect to FIG. 2, with the primary difference being that the RF ports 330 and the calibration ports 332 face upwardly as shown in FIGS. 4 and 5.

The eight RF ports 330 and the ninth calibration port 332 form an array of connector ports. Each port 330, 332 may be connected to an RF port on a RRU 32 by a suitable connectorized jumper cable such as, for example, a coaxial jumper cable (not shown). Accordingly, jumper cables that are external to the antenna may extend between each RF port 330/calibration port 332 and a respective port (not shown) on the remote radio unit 32 that is mounted on the back of the antenna 320. In the illustrated embodiment, nine coaxial jumper cables would extend between the nine ports that are provided on each antenna 320 and RRU's 32.

As cellular operators upgrade their networks to support fifth generation (“5G”) service, the base station antennas that are being deployed are becoming increasingly complex. For example, due to space constraints and/or allowable antenna counts on antenna towers of existing base stations, it may not be possible to simply add new antennas to support 5G service. Accordingly, cellular operators are opting to deploy antennas that support multiple generations of cellular service by including arrays of radiating elements that operate in a variety of different frequency bands in a single antenna. Thus, for example, it is common now for cellular operators to deploy a single base station antenna that supports service in three, four or even five different frequency bands. Moreover, in order to support 5G service, these antennas may include multi-column arrays of radiating elements that support active beamforming. Cellular operators are seeking to support all of these services in base station antennas that are comparable in size to conventional base station antennas that supported far fewer frequency bands. This raises a number of challenges.

One challenge in implementing the above-described base station antennas is that the number of RF ports included on the antenna is large and increasing. Antennas having six, eight or twelve RF ports are common, while newer antennas may require far more RF connections. For example, a base station antenna may include two linear arrays of low-band radiating elements, two linear arrays of first mid-band radiating elements, a four column planar array of second mid-band radiating elements and a four column planar array of high-band radiating elements. All of the radiating elements may comprise dual-polarized radiating elements. Consequently, each column of radiating elements will be fed by two separate connector ports on a radio, and thus a total of twenty-four RF connector ports are required on the base station antenna to pass RF signals between the twelve separate columns of radiating elements and their associated RF ports on the cellular radios. Moreover, each of the four column planar arrays of radiating elements are operated as a beamforming array, and hence a calibration connector port is required for each such array, raising the total number of RF ports required on the antenna to twenty-six. Other ports such as control ports are also typically required which are used, for example, to control electronic tilt circuits included in the antenna.

In order for the antenna to operate properly it is necessary that each jumper cable 60 connects one port on the antenna to the correct corresponding port on the RRU. If the RF ports on the antenna are misconnected to RF ports on the RRU, the beam forming capability of the RRU may be degraded or destroyed. One challenge in installing and maintaining base station antennas such as described above, is that as the number of RF ports on the antenna and RRUs increases, the opportunity for the installer to connect a RF port on the antenna to the wrong RF port on the RRU increases.

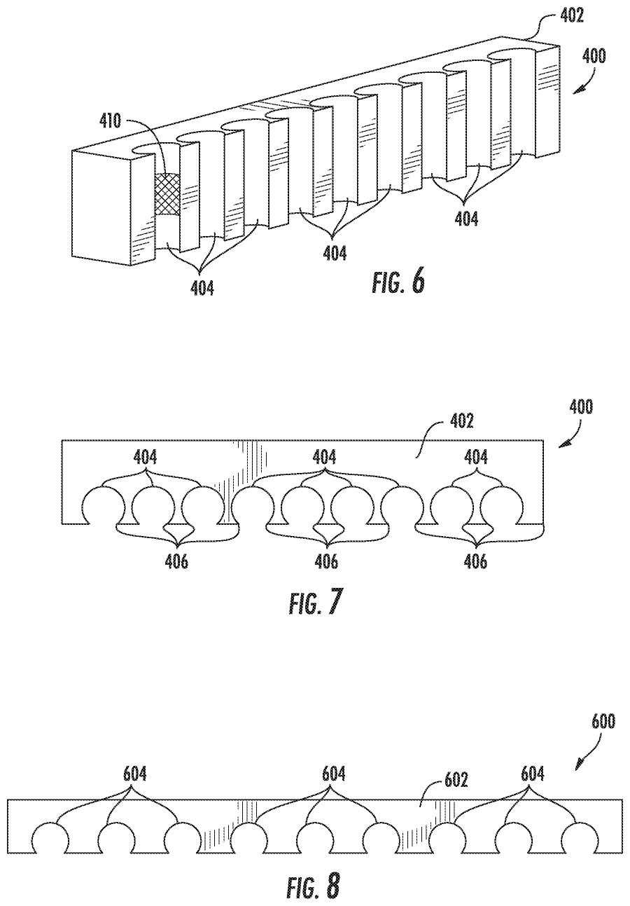

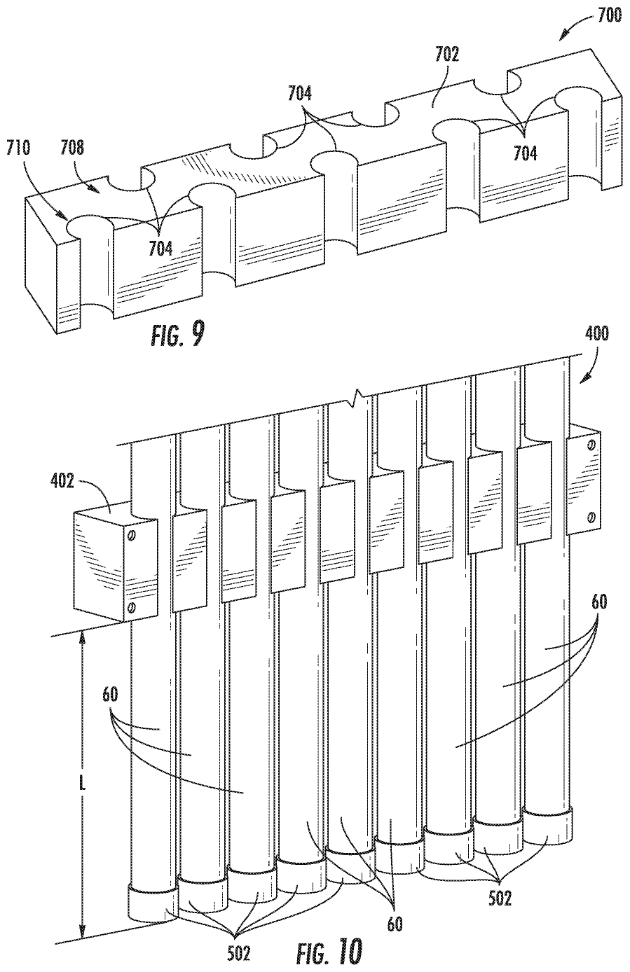

The jumper cable management system of the invention facilitates the installation of electronic communications equipment such as the antenna and the RRU and minimizes the opportunity for jumper cable misconnections to occur. The jumper cable management system of the invention uses a bracket to organize the jumper cables and to hold the jumper cables in a predetermined proper order such that the chance of a misconnecting a jumper cable during installation is lowered and a misconnected jumper cable will be readily apparent to the installer. Referring to FIGS. 6, 7 and 10, one embodiment of the jumper cable management brackets 70-1, 70-2 of FIG. 2 is shown generally at 400. The bracket 400 comprises a resilient, deformable body 402 made of material such as plastic, rubber or the like. While the body 402 is resiliently deformable, in some embodiments the body 402 may be stiff enough that it holds its shape absent a force being applied to the material. In some embodiments, the material of the body may be resiliently deformable while in other embodiments the geometry of the body may provide the deformable resiliency. While the body 402 is shown as a rectangular block of material the body may have other shapes. A plurality of substantially C-shaped channels 404 are formed in and extend through the body 402. In one embodiment, the channels 404 extend parallel to one another. The channels 404 have an internal shape that matches the shape of the jumper cables 60 that are to be retained by the bracket 400. Because a standard communication jumper cable 60 is typically tubular in shape, the channels 404 have a generally cylindrical shape. The diameter of the channels 404 may be equal to or slightly less than the outer diameter of the jumper cables 60 such that the channels 404 retain the jumper cables in a secure manner where movement of a jumper cable 60 in a channel 400 is difficult. In this manner, the placement of the bracket 400 relative to the jumper cables 60 may be substantially fixed.

Each of the channels 404 may be formed with an opening 406 such that the jumper cables 60 may be forced into the channels 404 through the opening 406. The material of the body 402 is sufficiently deformable that the body 402, or portions of the body, can deform to allow the jumper cable 60 to pass between the edges of the opening 406 and into the channel 404. The resiliency of the material of the body 402 allows the body 402 to return to the undeformed state where the jumper cables 60 are securely held in the channels 404. The interior wall of the channels 404 may extend greater than 90 degrees but less than 360 degrees to create the opening 406 while still providing a gripping engagement with the jumper cables 60. For example, the channels 404 may extend for approximately 220-270 degrees depending on the flexibility of the material of the body 402.

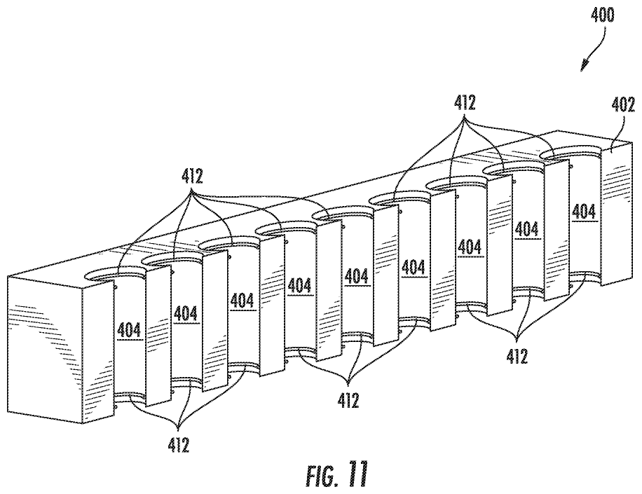

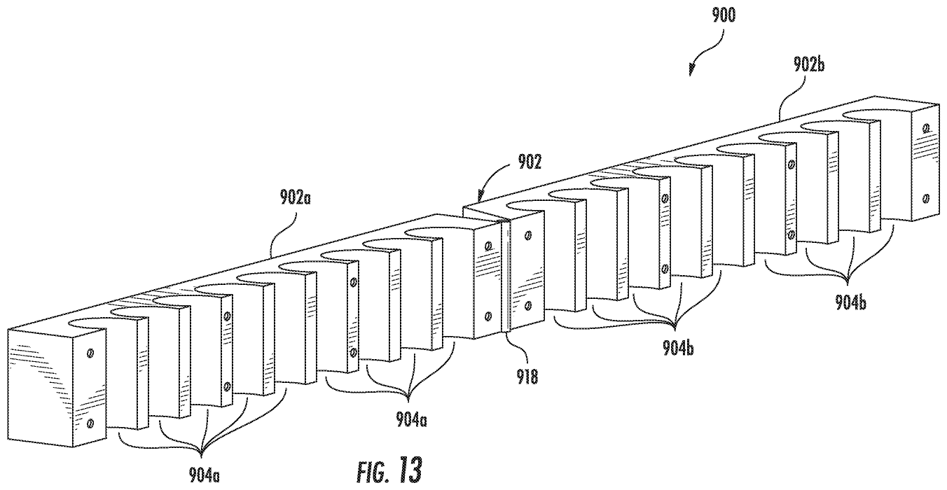

FIG. 10 shows a bracket 400 retaining a plurality of jumper cables 60. The length L of the jumper cables 60 extending from the bracket 400 to the connectorized ends of jumper cables 60 may be controlled such that enough jumper cable is provided that the installer can connect the jumper cables 60 to the associated ports on the antenna and/or RRU but the length L is limited such that the installer can identify if the jumper cables 60 cross one another thereby indicating a misconnected jumper cable. The term “port” is used herein to refer to RF ports and calibration ports. FIG. 7 shows bracket 400 where the channels 404 are more relatively closely spaced than the channels 604 in the body 602 of the bracket 600 of FIG. 8. The bracket 600 may otherwise be the same as the bracket 400 as previously described. The spacing of the channels 404, 604 may be selected to align the jumper cables 60 retained in the channels with the ports on the RRU and/or antenna to which the jumper cables are to be connected. In the embodiments of FIGS. 6, 7 and 8, the channels 404, 604 are arranged in a single straight line. This arrangement may be advantageously used with communications equipment having the ports arranged in a single straight line such as the antennas shown in FIGS. 3, 4 and 5.

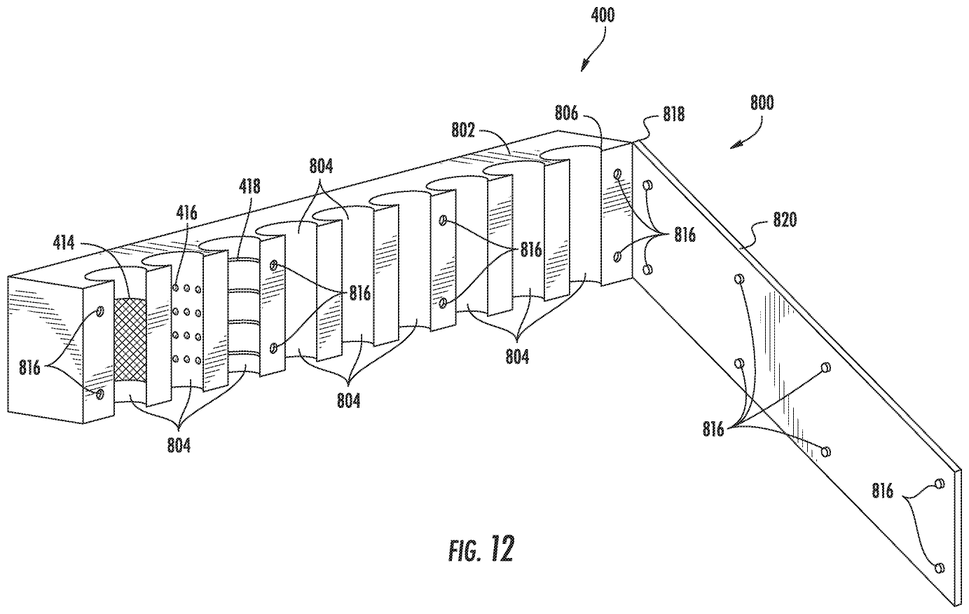

In this regard, reference is made to FIG. 9 which shows a bracket 700 in which the channels 704 do not extend in a straight line along the length of body 702. In the bracket of FIG. 9, the channels 704 are spaced in two dimensions with a first row 708 of channels 704 extending in a straight line and a second row 710 of channels 704 extending in a straight line where the rows 708, 710 are laterally spaced from one another and the channels 704 in the two rows are staggered relative to one another. Such an arrangement may be used, for example, to connect to an antenna such as shown in FIG. 2 where the ports 130, 132 are arranged in two laterally offset rows. This allows the channels 704 of the bracket, and the jumper cables retained in the channels 704, to be aligned with the ports even where the ports are not arranged in a straight line. In some embodiments, the pattern of the channels is selected to match the pattern of the ports to which the jumper cables are to be connected. Other patterns of the channels in addition to those specifically described herein may be provided where the pattern of the channels is selected to match the pattern of the ports. As previously explained, this arrangement allows the installer to quickly and easily observe if one or more of the jumper cables is out of alignment and therefore misconnected when the jumper cables 60 are connected to the antenna or the RRU. The bracket 700 may otherwise be the same as the bracket 400 as previously described.

It is to be understood that the ports on the antenna and the ports on the RRU connected to that antenna may be arranged in different patterns such that different brackets 70-1, 70-2 may be used at each end of the jumper cables 60 with each bracket specifically configured to match the port layout of either the antenna or the RRU, as shown in FIG. 2, for example. In some embodiments, the brackets 70-1 and 70-2 may be the same. Moreover, only one bracket may be used at one end of the jumper cables 60.

Referring to FIG. 10, because the length L of jumper cable 60 that extends from the bracket may affect the effectiveness of the bracket in controlling the proper connection of the jumper cables, the position of the bracket on the jumper cables may be fixed. If the length L of the extending jumper cable 60 is too great, the installer may not receive visual feedback that the jumper cables have been misconnected. If the length L of the extending jumper cable 60 is too small, it may be difficult for the installer to align and connect the plurality of jumper cables to the plurality of ports. In this regard, a typical communication jumper cable uses a threaded connector 502 that must be tightly secured to a mating threaded connector on the port. If the length L of jumper cable is too short it may be difficult for the installer to access and engage the connectors and rotate the threaded connector on the jumper cables. To fix the position of the bracket on the jumper cables a variety of fixing mechanisms may be used. It should be understood that while the length L is fixed in some embodiments, the fixing mechanisms do not have to be absolute and some relative movement between the jumper cables and the bracket may be allowable or even desirable to facilitate installation of the system. The system is to be used by a highly trained installer such that some relative movement may be allowed because the installer can be trained on the proper usage of the bracket. As one example, in some embodiments the length L may be approximately 6-14 inches although this dimension may vary.

In some embodiments, the compression of the deformable, resilient body 400 on the jumper cable may provide a sufficient fixing mechanism where the position of the bracket is fixed relative to the jumper cable by friction and/or the compression of the jumper cable and/or the bracket. In other embodiments, other mechanisms may be used. For example, adhesive 410 (FIG. 6) may be applied in the channels prior to the loading of the jumper cables. In other embodiments, the fixing mechanism may comprise a technique such as sonic welding. In still other embodiments, the fixing mechanism may be provided by using an insert molding technique where the jumper cables are inserted into the mold for the bracket and the material of the bracket, such as plastic, is shot around the jumper cables. In such a molding technique the channels may completely surround the jumper cables 60. In still other embodiments, the fixing mechanism may comprise rubber grommets 412 (FIG. 11), a roughened surface 414, dimples 416, raised ridges 418 or the like (FIG. 12) that may be located on an interior wall of the channels to increase the compression/fiction fit between the jumper cables and the channels. In still other embodiments, the brackets may be more loosely mounted on the jumper cables. In such a loose mounting configuration, the jumper cables 60 may be provided with a visual indicator of the proper location of the bracket. For example, a visual indicator may be painted, printed, applied by decal or sticker or the like on the jumper cable indicating the proper location of the bracket on the jumper cable to check for misconnected jumper cables. The fixing mechanisms described herein may be used in any of the embodiments described herein.

FIG. 12 shows another embodiment of the bracket 800. In the embodiment of FIG. 12, the bracket 800 may comprise a body 802 of resilient, deformable material such as plastic, rubber or the like. While the material may be resiliently deformable as previously described, it may also be made relatively rigid. A plurality of substantially C-shaped channels 804 are formed in and extend through the body 802. The channels 804 may extend parallel to one another. The channels 804 have an internal shape that matches the shape of the jumper cables 60 that are to be retained by the bracket 800. Because a standard communication jumper cable is typically tubular, the channels 804 may have a generally cylindrical shape. The diameter of the channels may be equal to or slightly less than the outer diameter of the jumper cables such that the channels retain the jumper cables in a secure manner where movement of the jumper cable in the channel is difficult. In this manner, the placement of the bracket relative to the jumper cables may be fixed as previously described.

Each of the channels 804 may be formed with an opening 806 such that the jumper cables 60 may be inserted into the channels 804 through the opening 806. A door 820 is pivotably connected to the body 802 at a hinge 818 and is rotatable about the hinge 818 between an open position and a closed position. The hinge 818 may be a living hinge where the door 820 and body 802 are formed of one-piece of material, such as molded plastic. Alternatively, the hinge 818 may be a separate mechanical structure that pivotably connects the door 820 to the body 802. In the open position of the door 820, the jumper cables 60 may be inserted into the channels 804 through openings 806. In the closed position of the door 820, the door 820 closes the channel openings 806 to secure the jumper cables 60 in the bracket 800. The door 820 may be retained in the closed position by mating locking mechanisms 816 on the door 820 and the block 802. For example, the locking mechanisms 816 may comprise deformable members on one of the door 820 or the block 802 that engage mating apertures formed on the other one of the door 820 or the block 802. The locking mechanisms 816 may also include separate fasteners such as screws that engage threaded holes on the door and or body or snap clips. The locking mechanisms 816 may be releasable such that the door 820 may be opened after the locking mechanism 816 is engaged or the locking mechanism 816 may be permanent in that the door 820 is permanently secured to the block 802 after the locking mechanism is engaged.

The material of the body 802 may be sufficiently deformable that the body 802 may deform to allow the jumper cables 60 to pass between the edges of the openings 806 and into the channels 804. The resiliency of the material allows the block 802 to return to the undeformed state to hold the jumper cables 60 in the channels 804 as previously described. However, because the door 820 is used to retain the jumper cables 60 in the body 802, the body 802 may be made of a more rigid material where the jumper cables 60 may be inserted into the channels 804 without deforming the body where the door 820 exerts the holding force on the jumper cables 60.

FIG. 13 shows another embodiment of the bracket 900. In the embodiment of FIG. 13, the bracket 900 may be considered to include a body 902 formed by two body portions 902a and 902b pivotably connected to one another at a hinge 918 and pivotable between an open position and a closed position in a clamshell fashion. The hinge 918 may be a living hinge where the body portions 902a and 902b are formed of one piece of material such as molded plastic. Alternatively, the hinge 918 may be a separate mechanical structure that pivotably connects the two body portions 902a and 902b. The body portions 902a and 902b may be made of resiliently deformable material such as plastic, rubber or the like. The body portions 902a, 902b may also be relatively rigid.

A plurality of channel portions 904a, 904b are formed in the body portions 902a and 902b, respectively. The channel portions 904a, 904b may extend parallel to one another and through the body portions 902a, 902b. When the body portions 902a, 902b are in the closed position, the channel portions 904a on body portion 902a are aligned with the channel portions 904b on body portion 902b to create complete channels that extend through the bracket 900. The channel portions 904a, 904b have an internal shape that matches the shape of the jumper cables that are to be retained by the bracket 900. Because a standard communication jumper cable is typically tubular, the complete channels have a generally cylindrical shape. The diameters of the complete channels may be equal to or slightly less than the outer diameter of the jumper cables 60 such that the complete channels retain the jumper cables 60 in a secure manner where movement of the jumper cable in the complete channels is difficult. In this manner, the placement of the bracket 900 relative to the jumper cables 60 may be fixed. In the embodiment of FIG. 13, the channel portions 904 are formed as semicircles in cross-section such that when the body portions 902a and 902b are in the closed position, the channel portions 904a, 904b align to create cylindrical channels. The material of the body portions 902a, 902b may be sufficiently deformable that they deform when the jumper cables 60 are inserted into the channels. The resiliency of the material allows the body portions 902a, 902b to return toward the undeformed state to hold the jumper cables 60 in the channels as previously described. However, because the body portions 902a, 902b close to trap the jumper cables 60 in the bracket 900, the body portions 902a, 902b may be made of a more rigid material where the jumper cables 60 may be inserted into the channels 904a, 904b without deforming the body where the closing of the clam shell structure exerts the holding force on the jumper cables 60

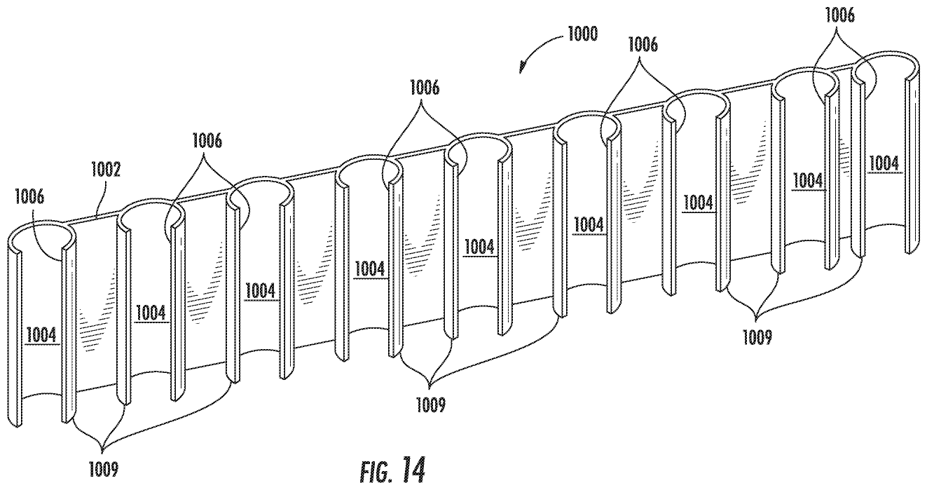

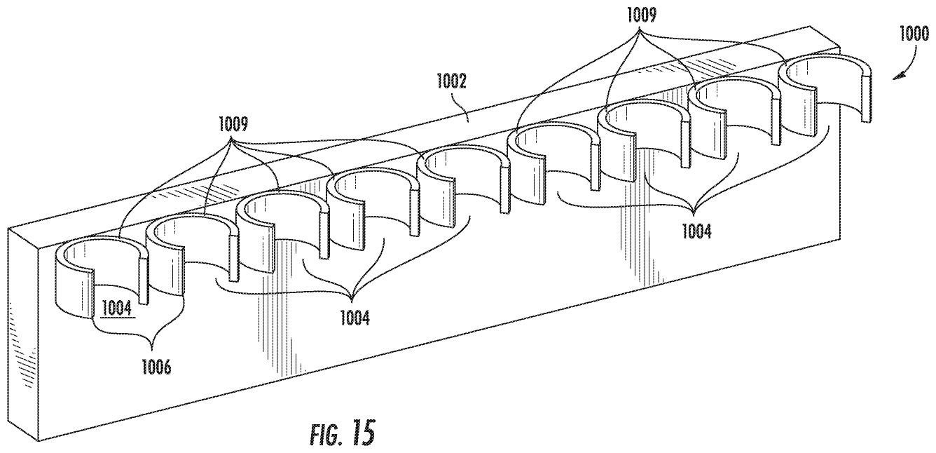

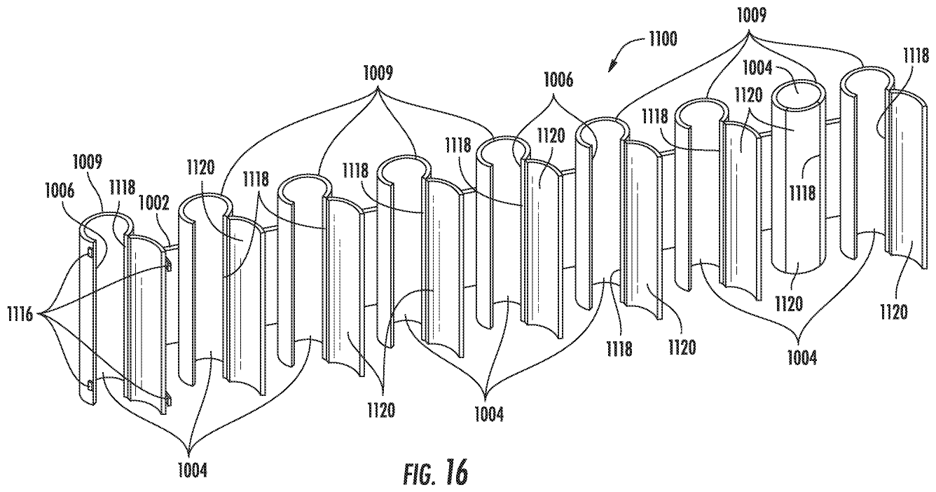

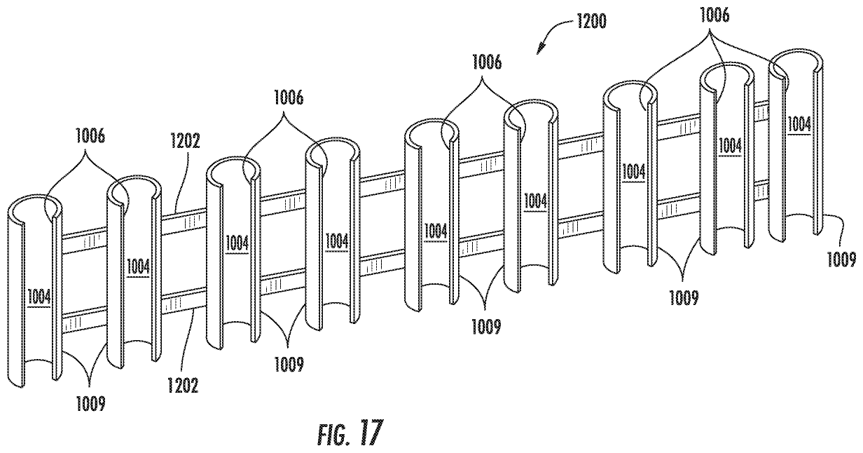

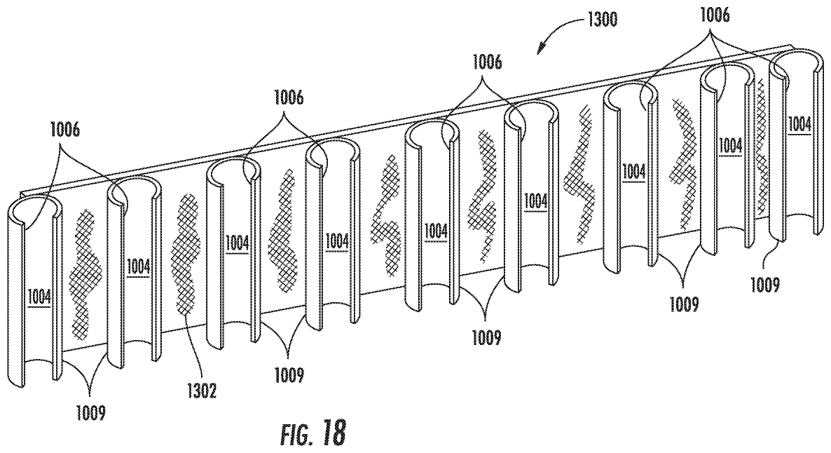

FIGS. 14 and 15 show another embodiment of the bracket 1000. In the embodiment of FIGS. 14 and 15, the channels 1004 are formed as cylindrical tubular members 1009 that are fixed to a common connecting member 1002. While in the illustrated embodiment, the channels 1004 are formed by cylindrical tubular members 1009 that define the interior cylindrical channels 1004, the exterior of the members may 1009 be any shape provided that they define interior cylindrical channels 1004. The channels 1004 may be formed by separate members 1009 attached to the connecting member 1002 or the members 1009 and connecting member 1002 may be formed as one-piece such as of molded plastic. The channels 1004 and members 1009 may extend for the same height as the connecting member 1002 as shown in FIG. 14, or the channels 1004 and members 1009 may extend for less than the height of the connecting member 1002 as shown in FIG. 15, or the channels 1004 and members 1009 may extend for a height greater than the connecting member (see FIG. 17). The members 1009 may be made of a relatively resilient, deformable material to allow the jumper cables 60 to be inserted into the openings 1006 of the channels 1004. The connecting member 1002 may be made of flexible or rigid material. In some embodiments, the connecting member 1002 comprises a flat planar member.

The diameter of the channels 1004 may be equal to or slightly less than the outer diameter of the jumper cables 60 such that the channels 1004 retain the jumper cables in a secure manner where movement of a jumper cable 60 in a channel 1004 is difficult. In this manner, the placement of the bracket 1000 relative to the jumper cables 60 may be substantially fixed. The channels 1004 may include any of the fixing mechanisms described above.

Each of the channels 1004 may be formed with an opening 1006 such that the jumper cables 60 may be forced into the channels 1004 through the openings 1006. The members 1009 are sufficiently deformable that the members 1009 can deform to allow a jumper cable 60 to pass between the edges of the opening 1006 and into the channel 1004. The resiliency of the members 1009 allows the members 1009 to return to the undeformed state where the jumper cables 60 are securely held in the channels 1004. The channels 1004 may extend greater than 90 degrees but less than 360 degrees to create the opening 1006 while still providing a gripping engagement with the jumper cables 60. For example, the channels 1004 may extend for approximately 220-270 degrees depending on the flexibility of the member 1009.

FIG. 16 shows another embodiment of the bracket 1100 that is similar to the bracket shown in FIG. 14 except that hinged doors 1120 are provided on each of the members 1009 to close the channels 1004 and to trap the jumper cables in the channels. Each of the channels 1004 may be formed with an opening 1006 such that the jumper cables 60 may be inserted into the channels 1004 through the openings 1006. A door 1120 is pivotably connected to the members 1009 at a hinge 1118 and is rotatable about the hinge 1118 between an open position and a closed position. The hinge 1118 may be a living hinge where the door 1120 and members 1009 are formed of one-piece of material, such as molded plastic. Alternatively, the hinge 1118 may be a separate mechanical structure that pivotably connects the door 1120 to the member 1009. In the open position of the door 1120, the jumper cables 60 may be inserted into the channels 1004 through openings 1006. In the closed positon of the door 1120, the door 1120 closes the channel openings 1006 to secure the jumper cables 60 in the bracket 1100. The door 1120 may be retained in the closed position by mating locking mechanisms 1116 on the door 1120 and the member 1009. For example, the locking mechanisms 1116 may comprise deformable members on one of the door 1120 or the body 1009 that engage mating apertures formed on the other one of the door 1120 or the body 1009. The locking mechanisms 816 may also include separate fasteners such as screws that engage threaded holes on the door and or body. The locking mechanisms 1116 may be releasable such that the door 1120 may be opened after the locking mechanism 1116 is engaged or the locking mechanism 1116 may be permanent in that the door 1120 is permanently secured to the body 1009 after the locking mechanism is engaged.

The material of the body 1009 may be sufficiently resiliently deformable that the body 1009 can deform to allow the jumper cables 60 to pass between the edges of the openings 1006 and into the channels 1004. The resiliency of the material allows the members 1009 to return to the undeformed state to hold the jumper cables 60 in the channels 1004. The wall of the channels may extend from greater than 90 degrees but less than 360 degrees to create the opening 1006. For example, the channels 1004 may extend for approximately 220-270 degrees depending on the flexibility of the material of the member 1009 as previously described. However, because the door 1120 is used to retain the jumper cables 60 in the channels 1004, the members 1009 may be made of a more rigid material where openings 1006 may be wide enough that the jumper cables 60 may be inserted into the channels 1004 without deforming the member 1009. In such an embodiment, the door 1120 exerts the holding force on the jumper cables 60.

FIG. 17 shows another embodiment of the bracket 1200. In the embodiment of FIG. 17, the channels 1004 are formed in members 1009 that are fixed to a connecting member or members 1202. The members 1009 may be formed as previously described with reference to FIGS. 14-16. The members 1009 may be formed as separate members attached to the connecting members 1202 or the members 1009 and connecting members 1202 may be formed as one piece such as of molded plastic. In this embodiment, the connecting members 1202 may be formed as relatively thin, elongated members to increase the flexibility of the connecting members 1202. The connecting members 1202 may be made as thin relatively flexible members such as plastic or rubber strips, metallic or non-metallic jumper cables, cords or the like.

FIG. 18 shows another embodiment of the bracket 1300. In the embodiment of FIG. 18, the 1004 channels are formed as members 1009 that are fixed to a connecting member or members 1302. The members 1009 may be formed as previously described with reference to FIGS. 14-16. The connecting member 1302 may be formed as a piece of a flexible material such as a textile, fabric, canvas or the like such that the members 1009 and channels 1004 are flexibly connect to one another.

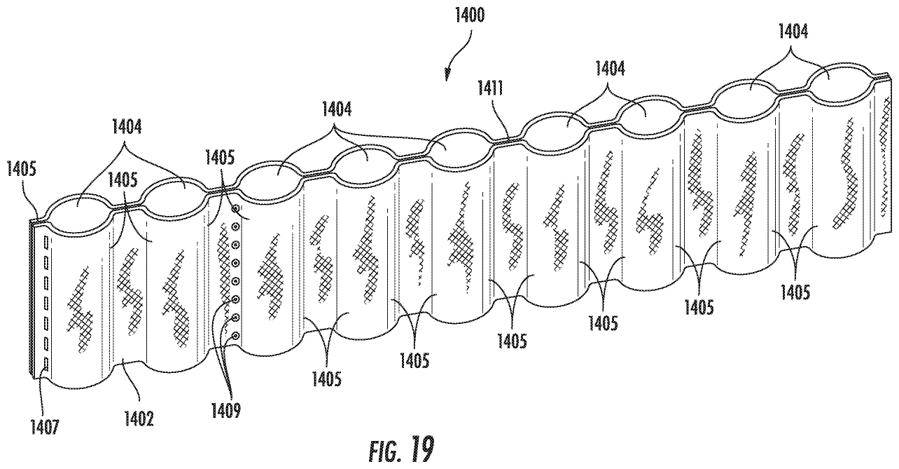

FIG. 19 shows another embodiment of the bracket 1400. In the embodiment of FIG. 19, the channels 1404 and the connecting member 1402 are formed of a flexible material such as a textile, fabric, canvas or the like such that the channels 1404 are flexibly connected to one another. In such an embodiment, substantially the entire bracket 1400 may be made of the same type of flexible material with the channels 1404 and the connecting member 1402 being formed of one or more strips of material. Joints 1405 may be formed by sewing 1407, rivets 1409, adhesive 1411 or the like to create the channels 104 and the connecting member 1402 in the material. The fixing mechanisms described herein may be used in any of the embodiments described above.

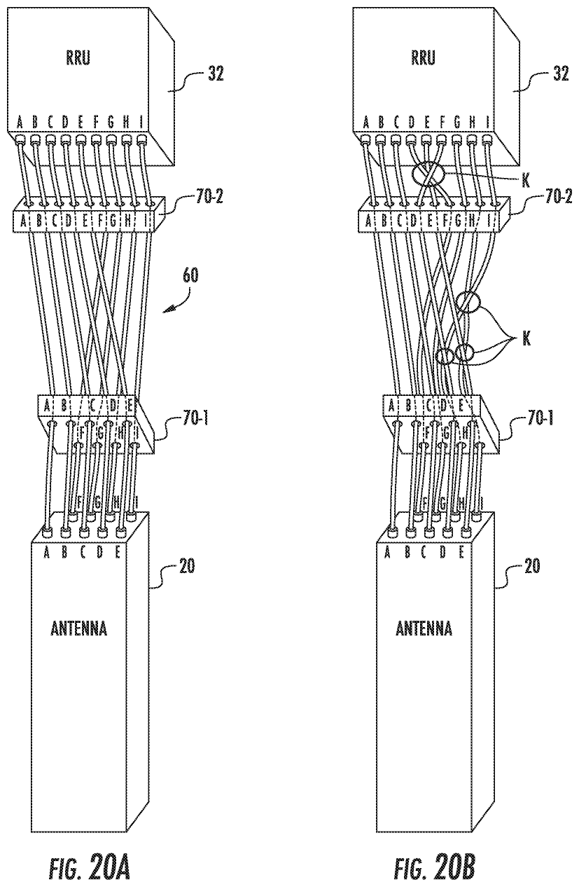

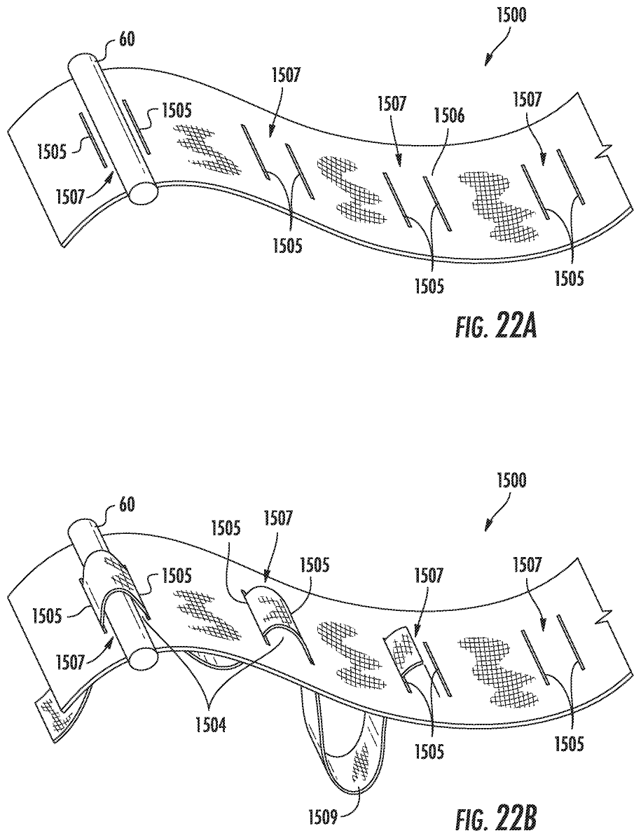

FIGS. 22A and 22B show another embodiment of the bracket 1500. In the embodiment of FIG. 22, the channels 1504 and the connecting member 1506 are formed of a flexible strip of material such as a textile, fabric, canvas or the like such that the channels 1404 are flexibly connected to one another. The connecting member 1506 comprises a strip of textile material having a plurality of slots or slits 1505 formed therein. The slits 1505 are arranged in pairs 1507 where the distance between the slits 1505 of each pair 1507 is approximately the same as the width of a cable 60. A second strip of textile material 1509 is woven or interlaced through the slits 1505 to create the channels 1504 and trap the cables 60 in the channels 1504. As is evident from FIGS. 20A and 20B, the second strip of material is alternately The second strip of textile material 1509 may be attached to the connecting member 1506 using any of the attachment mechanisms described above with reference to FIG. 19 including sewing 1407, rivets 1409, adhesive 1411 or the like. Because the engagement of the second strip of material 1509 with the first strip of material 1506 at slits 1505 creates the joints that form the channels 1504 the second strip of material 1509 may be attached to the connecting member 1506 only at the ends of the two strips of material. In other embodiments, the attachment mechanisms may be applied at every intersection between the two strips 1506, 1509 (where the second strip 1509 passes through slits 1505) or at least at some of the intersections between the two strips 1506, 1509. The attachment mechanisms as described with respect to FIGS. 19 and 22 may be applied after the cables 60 are inserted into the channels.

A bracket as described herein is used to facilitate the proper installation and connection of the jumper cables to the RRU and the antenna. Once the jumper cables 60 are properly installed, the bracket is not necessarily required for the proper operation of the antenna. As a result, in some embodiments, the bracket need not be made especially durable or long-lasting and the bracket may be removed after installation.

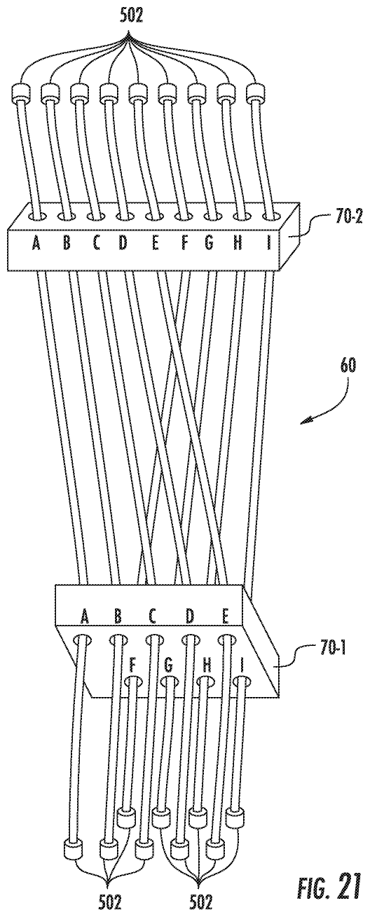

An embodiment of a method of using, and the operation of, the jumper cable management system of the invention will now be described with respect to FIGS. 20A and 20B. FIG. 20A shows a properly connected RRU 32 and antenna 20 while FIG. 20B shows an improperly connected RRU 32 and antenna 20. The RRU 32 has a linear array of ports A through I and the antenna 20 has a first row of ports A through E offset from a second row of ports F through I. Other arrangements of the ports may be found in other embodiments of the RRU and/or the antenna. In a properly connected system, ports A-I on RDU 32 should be connected to ports A-I on the antenna 20, respectively, as shown in FIG. 20A. A first bracket 70-1 is provided adjacent the first end of the jumper cables 60 that connect to antenna 20. The first bracket 70-1 has a pattern of channels A-I that correspond generally to the pattern of ports on the antenna 20. A second bracket 70-2 is provided adjacent the second end of the jumper cables 60 that connect to RRU 32. The second bracket 70-2 has a pattern of channels A-I that correspond generally to the pattern of ports on the RRU 32. The jumper cables 60 are mounted in the brackets 70-1 and 70-2 such that the jumper cable that connects to ports A on the antenna 20 and the RRU 32 is located in the channels A on brackets 70-1 and 70-2 that correspond to ports A on the RRU 32 and the antenna 20. The jumper cables 60 may be mounted in suitable brackets 70-1, 70-2 by the equipment manufacturer/provider such that the jumper cables 60 and brackets 70-1, 70-2 are provided to the installer as a preassembled jumper cable assembly as shown in FIG. 21. The positions of the jumper cables 60 in the brackets 70-1, 70-2 correspond to the positions of the associated ports A-I on the antenna 20 and RRU 32, respectively. In this manner, the installer uses the jumper cable assembly with the jumper cables preassembled in the predetermined locations of the brackets.

As shown in FIG. 20A when the jumper cables 60 are properly attached, the jumper cables run in a direct line from a channel on the brackets 70-1, 70-2 to the associated port on the antenna 20 and RRU 32, respectively. If the jumper cables are misconnected, at least two of the jumper cables will cross one another between the bracket 70-2 and the RRU 32 or between the bracket 70-1 and the antenna 20 as shown at positions K in FIG. 20B. The misconnection of the jumper cables 60 will be visually apparent to the installer. Moreover, by controlling the length L of the jumper cables 60 extending from the brackets the misconnection of the jumper cables may be prevented in some circumstances. For example, referring to FIG. 20A after the first jumper cable is properly connected to port A on the RDU and port A on the antenna, it would be physically more difficult to connect the second jumper cable to any port other than port B because the available length L of the second jumper cable will limit the reach of that jumper cable.

To install the jumper cable assembly, the installer climbs the tower, or otherwise accesses the antenna and RRU, with the jumper cable assembly of FIG. 21 and beginning at either of the antenna 20 or RRU 32, installs the first jumper cable from bracket position A to port A. The installer then connects the jumper cables in order as they are loaded in the bracket to the associate ports. The installer can confirm the proper installation of the jumper cables both visually as explained with respect to FIGS. 20A and 20B and by the physical difficulty in connecting misaligned jumper cables. The process is then repeated to connect the jumper cables to the other one of the antenna and RRU.

The brackets also facilitate the installation of the jumper cables 60 in that the brackets function as jumper cable organizers and holders during the installation process. After the first jumper cable is connected to the first port on the RRU or antenna, the remaining jumper cables are held by the bracket in an orderly fashion where the installer has use of both hands to install the remaining jumper cables.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A cable management system for connecting an antenna and a radio unit comprising:
a plurality of jumper cables;
a bracket comprising a plurality of channels where one of the plurality of channels receives one of the plurality of jumper cables, wherein the position of the plurality of channels in the bracket corresponds to the position of a plurality of ports on communications equipment to which the plurality of jumper cables are to be connected.

2. The cable management system of claim 1, wherein the bracket comprises a body of resilient, flexible material.

3. The cable management system of claim 1, wherein the plurality of channels are substantially C-shaped.

4. The cable management system of claim 1, wherein a diameter of the one of the plurality of channels is equal to or slightly less than an outer diameter of the one of the plurality of jumper cables.

5. The cable management system of claim 1, wherein a fixing mechanism fixes the position of the one of the plurality of jumper cables relative to the one of the plurality of channels.

6. The cable management system of claim 5, wherein the fixing mechanism comprises at least one of friction between the one of the plurality of jumper cables and the one of the plurality of channels, compression of at least one of the plurality of jumper cables and the bracket, an adhesive, a sonic weld, an insert molded connection, a rubber grommet, a roughened surface, a plurality of dimples, and a raised ridge on the one of the plurality of channels.

7. The cable management system of claim 1, wherein the one of the plurality of channels comprises a lateral opening, the one of the plurality of jumper cables being inserted into the one of the plurality of channels through the lateral opening.

8. The cable management system of claim 7, further comprising a door for closing the lateral opening of the one of the plurality of channels.

9. The cable management system of claim 1, wherein the bracket comprises a first body portion pivotably connected to a second body portion where the first body portion is movable relative to the second body portion between an open position and a closed position.

10. The cable management system of claim 9, wherein the first body portion comprises a plurality of first channel portions and the second body portion comprises a plurality of second channel portions, wherein when the first body portion and the second body portion are in the closed position the plurality of first channel portions and the plurality of second channel portions combine to form the plurality of channels.

11. The cable management system of claim 1, wherein the plurality of channels are formed by a plurality of members and the plurality of members are connected to one another by a connecting member.

12. The cable management system of claim 11, wherein the connecting member is flexible.

13. The cable management system of claim 11, wherein each of the plurality of members includes an opening for receiving one of the plurality of jumper cables.

14. The cable management system of claim 11, wherein the connecting member comprises at least one of a plastic strip, a rubber strip, a metallic cable, a non-metallic cable, a cord, a textile, a fabric, and a canvas.

15. The cable management system of claim 1, wherein the bracket and the plurality of channels are formed from at at least one of a textile material, a fabric material, and a canvas material.

16. The cable management system of claim 15, wherein a plurality of joints are formed by at least one of sewing, rivets, and adhesive to create the plurality of channels.

17. The cable management system of claim 11, wherein the connecting member comprises a first strip of flexible material, and wherein a second strip of flexible material is woven to the first strip of material to create the plurality of channels.

18. The cable management system of claim 11, wherein the connecting member comprises a first strip of flexible material, and wherein a second strip of flexible material is interlaced through a plurality of slits in the first strip of flexible material to create the plurality of channels.

19. A cable management system for cellular communications system having a remote radio unit and an antenna where each of the antenna and the remote radio unit include a plurality of ports, the cable management system comprising: a jumper cable assembly connecting the plurality of ports on the antenna to the plurality of ports on the remote radio unit wherein the jumper cable assembly comprises a plurality of jumper cables configured to connect the plurality of ports on the antenna to the plurality of ports on the remote radio unit, and a bracket including a plurality of channels where one of the plurality of channels receives one of the plurality of jumper cables, the position of the plurality of channels in the bracket corresponding to the position of the plurality of ports on one of the antenna and the remote radio unit.

20. A method of connecting a remote radio unit to an antenna in a cellular communications system where each of the antenna and the remote radio unit include a plurality of ports, the method comprising: providing a jumper cable assembly comprising a plurality of jumper cables configured to connect the plurality on ports of the antenna to the plurality of ports on the remote radio unit, and a bracket including a plurality of channels where one of the plurality of channels receives one of the plurality of jumper cables; arranging the plurality of jumper cables in the plurality of channels wherein a position of the plurality of channels corresponds to the position of the ports on one of the antenna and the remote radio unit; and connecting the jumper cables to one of the antenna and remote radio unit based on the position of the plurality of channels in the bracket.
